(19) United States
(12) Patent Application Publication
(10) Pub. No.: US 2017/0134089 A1
(43) Pub. Date: May 11, 2017

(54) SYSTEM AND METHOD OF CONFIGURING AN OPTICAL NETWORK

(71) Applicants: Mohammad Mehdi Mansouri Rad, Ottawa (CA); Hamid Mehrvar, Ottawa (CA)

(72) Inventors: Mohammad Mehdi Mansouri Rad, Ottawa (CA); Hamid Mehrvar, Ottawa (CA)

(21) Appl. No.: 15/204,612

(22) Filed: Jul. 7, 2016

Related U.S. Application Data
(60) Provisional application No. 62/252,896, filed on Nov. 9, 2015.

(51) Int. Cl. H04B 10/079; H04B 10/27

(52) U.S. Cl. CPC H04B 10/07953; H04B 10/27

(57) ABSTRACT

Routing of optical paths through an optical network may account for both linear and non-linear effects of the physical layer when determining the route. The non-linear effects may be determined only as necessary, allowing the non-linear effects to be included in the routing determination for larger optical networks.

### CROSS REFERENCE TO RELATED APPLICATIONS

This application claims the benefit of priority to US Provisional Patent Application Ser. No. 62/252,896 filed on Nov. 9, 2015, the entire contents of which are incorporated herein by reference.

### TECHNICAL FIELD

The current disclosure relates to optical networks, and in particular to configuration optimization of optical networks.

### BACKGROUND

Optical networks establish lightpaths between sources and destinations. Information can be transmitted between the source and destination using a single wavelength or multiple wavelengths over a single lightpath or multiple lightpaths. Configuration of the components of the optical network to establish the lightpaths may be done statically or dynamically. Establishing lightpaths typically is performed using switches of various sizes at one or more network nodes interposed between the source and destination nodes. The performance characteristics of the physical layer, such as optical power losses, wavelength dependent losses, amplifier ASE noise accumulation, etc. may be calculated, computed or estimated and used in an attempt to determine an optimal routing through the optical network for lightpaths.

As the capacity and size of optical networks increase, dynamic configuration of the network components cannot efficiently incorporate information from the physical layer.

### SUMMARY

In accordance with the present disclosure there is provided a method for determining a route from a source to a destination of an optical network, the method comprising: determining an optical signal to noise ratio (OSNR) value for each one of a plurality of paths through the optical network from the source to the destination; selecting, as a candidate path, a path having the best OSNR value from the plurality of paths; determining if non-linear effects should be calculated for the candidate path; calculating non-linear effects for the candidate path and updating the OSNR value of the candidate path using the calculated non-linear effects when it is determined that non-linear effect should be calculated for the candidate path; and selecting a path from the plurality of paths having the best OSNR value as the route from the source to the destination.

In a further embodiment of the method, determining if non-linear effects should be calculated for the candidate path comprises determining if the candidate path includes at least one link suffering from non-linear effects.

In a further embodiment of the method, determining if the candidate path includes at least one link suffering from non-linear effects is based on one or more monitored parameters from one or more network components along the candidate path in the optical network.

In a further embodiment of the method, determining if the candidate path includes at least one link suffering from non-linear effects comprises: determining for one or more links that one or more parameters have crossed a threshold; and setting a non-linearity index flag for the one or more links that are determined to have one or more parameters that have crossed the threshold.

In a further embodiment of the method, the one or more monitored parameters are: requested from at least one of the one or more network components when required for determining if the candidate path includes at least one link suffering from non-linear effects; periodically requested from at least one of the one or network components; periodically received from at least one of the one or network components; or received from at least one of the one or network components when one or more of the monitored parameters changes more than a threshold amount.

In a further embodiment of the method, determining if non-linear effects should be calculated for the candidate path further comprises determining if the non-linear effects have already been calculated when it is determined the candidate path includes at least one link suffering from non-linear effects.

In a further embodiment of the method, determining if non-linear effects should be calculated for the candidate path further comprises, when the non-linear effects have already been calculated, determining if the non-linear effects already calculated should be updated.

In a further embodiment of the method, determining if non-linear effects should be calculated for the candidate path further comprises determining if a second-best OSNR value of the plurality of paths is within a threshold of the OSNR value of the candidate path.

In a further embodiment of the method, determining if non-linear effects should be calculated for the candidate path comprises determining if the OSNR value of the candidate path is within an acceptable range threshold for the destination.

In a further embodiment of the method, selecting the path having the best OSNR value as the route comprises verifying that the updated OSNR value of the candidate path is the best OSNR value.

In a further embodiment of the method, selecting the path having the best OSNR value as the route comprises selecting another candidate path having the best OSNR value.

In a further embodiment of the method, selecting the path having the best OSNR value as the route comprises recursively applying the method for determining the route until the selected candidate path does not need to have non-linear effects of the candidate path calculated.

In a further embodiment of the method, determining the OSNR value for each one of the plurality of paths comprises: determining the OSNR value of each link of the respective path based on linear effects of the link.

In a further embodiment of the method, determining the OSNR value for each one of the plurality of paths comprises determining OSNR values for one or more assigned wavelengths on each link of the respective path based on linear effects of the link for the wavelength.

In a further embodiment of the method, the linear effects include one or more of: transmission loss; fiber attenuation; coupling inefficiency; and amplifier noise.

In a further embodiment of the method, the calculation of the non-linear effects include one or more of: Stimulated Raman Scattering (SRS); Stimulated Brillouin Scattering (SBS); Optical Kerr effect; Self Phased Modulation (SPM); Cross Phase Modulation (XPM); and Four-Wave Mixing (FWM).

In a further embodiment of the method, the calculation of non-linear effects incorporates one or more linear effects.

In a further embodiment, the method further comprises establishing the route within the optical network.

In accordance with the present disclosure there is provided a controller for determining a route from a source to a destination of an optical network, the controller comprising: at least one memory unit for storing instructions; at least one processor for executing instructions stored in the at least one memory unit, the executed instructions configuring the controller to carry out a method for determining a route from a source to a destination of the optical network, the method comprising: determining an optical signal to noise ratio (OSNR) value for each one of a plurality of paths through the optical network from the source to the destination; selecting, as a candidate path, a path having the best OSNR value from the plurality of paths; determining if non-linear effects should be calculated for the candidate path; calculating non-linear effects for the candidate path and updating the OSNR value of the candidate path using the calculated non-linear effects when it is determined that non-linear effect should be calculated for the candidate path; and selecting a path, of the plurality of paths, having the best OSNR value as the route from the source to the destination.

In a further embodiment of the controller, the at least one memory unit and at least one processor comprise a plurality of memory units and a plurality of processors of network components of the optical network.

In a further embodiment of the controller, the network components comprise one or more of: a plurality of access nodes; a plurality of optical switches; one or more gateways; and one or more control servers.

In a further embodiment of the controller, the plurality of network components are communicatively coupled by a control plane.

In a further embodiment of the controller, determining the OSNR values for each of the plurality of paths and calculating the non-linear effects is based on one or more monitored parameters from one or more network components in the optical network.

In a further embodiment of the controller, the one or more gateways: periodically retrieve at least one of the monitored parameters from one or more of the plurality of optical switches and store in at least one of the one or more control servers; or retrieve at least one of the monitored parameters from one or more of the plurality of optical switches when determining the OSNR values or calculating the non-linear effects.

In a further embodiment of the controller, one or more of the plurality of optical switches: periodically push at least one of the monitored parameters; or push at least one of the monitored parameters when the monitored parameters change.

### BRIEF DESCRIPTION OF THE DRAWINGS

Embodiments are described herein with reference to the appended drawings, in which:

FIG. 1 depicts a schematic of an optical network and control system;

FIG. 2 depicts a method for selecting route based on OSNR;

FIG. 3 is a schematic representation of a distributed controller for selecting a route based on OSNR values;

FIG. 4 depicts a method of controlling an optical network;

FIG. 5 depicts a method of determining an optical signal to noise ratio (OSNR) for a path;

FIG. 6 depicts an example optical network;

FIG. 7 is a graph of the probability of a path suffering from non-linear effects; and

FIG. 8 is a graph of computational savings based on percentage of non-linear links in a network.

### DETAILED DESCRIPTION

Dynamically configuring components of an optical network in real-time or near real-time may help in delivering improved services and or functionality such as improved traffic setup, handling, grooming and fault management. The configuration functionality available to a controller may determine a route and particular wavelength assignment to use in establishing a lightpath. The configuration functionality may attempt to determine an optimal, or near-optimal, path, by utilizing physical layer performance information. The configuration of the path may be carried out in real-time or near real-time. The route and wavelength assignment (RWA) determination described further herein can account for both linear effects in physical layer performance as well as non-linear effects when advantageous. As described further below, the route determination may be based on linear effects of the physical layer first, and if it is determined necessary the route determination may be augmented by accounting for non-linear effects of the physical layer.

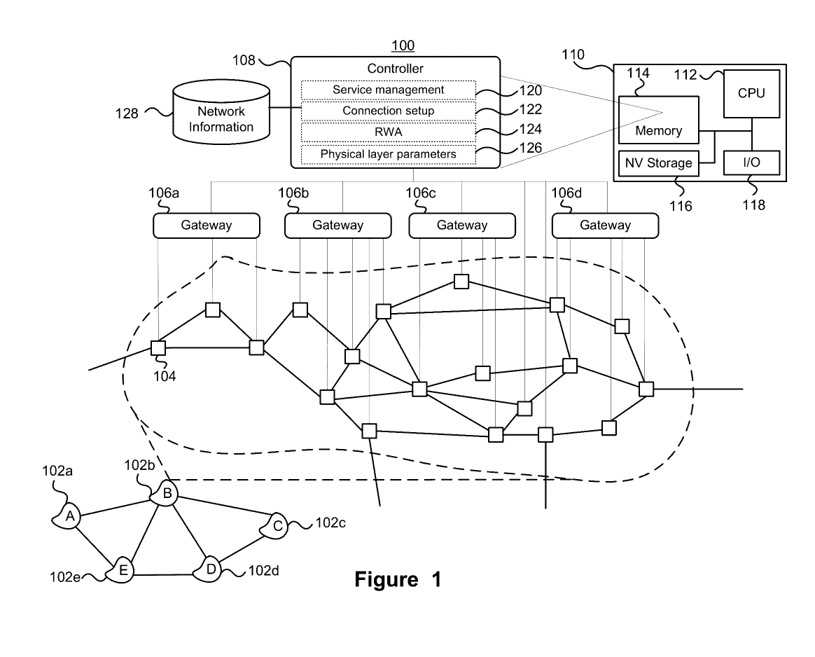

FIG. 1 depicts a schematic of an optical network and control system. The optical network and control system 100 comprises an optical network and a controller 108 for configuring components of the optical network. The optical network may comprise a number of interconnected optical networks 102a, 102b, 102c, 102d, 102e (referred to as optical networks 102). The group of optical networks 102 may provide a multi-domain network with each of the individual optical networks 102 providing separate domain. Each of the optical networks 102 may comprise a number of interconnected optical components, depicted as individual squares 104. The interconnected optical components 104 may include for example network access nodes, or optical switches typically utilizing reconfigurable add-drop multiplexer (ROADM) based architectures that are connected to other access nodes or switches via fiber optic cables. A network segment may correspond to a piece of the network between two connected access nodes. The access nodes 104 may be optimized to maintain the relative noise level introduced to each wavelength the same across the spectrum of wavelengths, which will substantially maintain the optical signal to noise ratio (OSNR) regardless of the wavelength. Per-wavelength power actuators of the access nodes manage launched power to ensure that the channel wavelengths passing through the photonic section experience the same amount of signal degradation. Maintaining the OSNR constant across different wavelengths allows upper layer configuration management to simplify the configuration strategy. This can allow for simplification in route and wavelength assignment calculations because the effect of a given section on each wavelength is the same. The OSNR need not be the same across different wavelengths, however when the OSNR differs for different wavelengths it may be necessary to calculate the OSNR value for each wavelength.

A data plane is established between the optical components 104 to carry the network traffic. Additionally, a control plane is also established within the optical network to provide a communication network between the network access nodes 104 and the controller 108. The control plane may be established over the data plane, for example using a time slot, or particular wavelength, of the data plane to transmit the control plane, or through a packet based network used to interconnect control and management of nodes 104. The control plane may connect one or more of the access nodes 104 directly to the controller 108, or through one or more gateways 106a, 106b, 106c, 106d. The control plane allows the controller 108 to request control information, such as performance related information, usage information, etc., from the network access nodes 104, and to send configuration commands to the network access nodes 104. The parameters monitored by nodes may be accessed in various ways, including, for example by periodically pulling or requesting the parameters from the nodes, pulling or requesting the parameters on demand when they are required, periodically pushing the parameters from the node for storage and subsequent access from the storage location, or pushing the parameters from the node for storage and subsequent access when the parameter changes. As depicted, the controller 108 may be provided by a server 110 comprising a processor 112 for executing instructions stored in memory 114. In addition to the memory 114, the server 110 may also include non-volatile storage 116 for long term storage of instructions and data. The server 110 may also include one or more input/output (I/O) components 118 for connecting the server to one or more other components. Although depicted as a single server 110, the functionality provided by the controller 108 may be distributed over a plurality of devices. Further multiple controllers may be provided by one or more servers.

The controller 108 may provide various functionality for configuring and controlling the optical network. For example, the controller 108 may provide service management functionality 120, connection setup functionality 122 as well as route and wavelength assignment (RWA) functionality 124. The controller may include physical layer parameter functionality 126 that can access the parameter information required for determining the OSNR of a link. The physical layer parameter functionality 126 may periodically request and receive the monitored parameters from the access nodes 104, either directly or through one or more gateways 106. The received parameters may be stored for example in a network information database 128. Additionally or alternatively, the physical layer parameter functionality 126 may request and receive the monitored parameters from the access nodes 104 when the parameters are required. Further still, the access nodes 104 may periodically push parameters to the physical layer parameter functionality 126 or may push parameters to the physical layer parameter functionality 126 when the parameters change, or change by at least a threshold amount. The functionality provided by the controller 108 may utilize network information stored in the database 128, or provided by the physical layer functionality 126, which may retrieve the parameter information from the nodes when required as well as information collected by the network access nodes or other network components. For example, the RWA functionality 124 may determine route and wavelengths for a particular path using network information 128 such as the network architecture and other network information as well as OSNR information provided by the network access components over the control plane.

When determining a path for a connection between a source and destination node, RWA functionality 124 may use estimations of the physical network layer of each link from the source to destination. The path that provides the best OSNR, while meeting other requirements may be selected for establishing the lightpath. Different RWA strategies may rely upon different information to determine the path to select and may perform full point-to-point calculations from source to destination. However, such calculation may require large tables for physical layer parameters. The large number of parameters may require large bandwidth in the control plane, fast polling of data from the network access nodes in order to update the information in the tables, reliable estimations, etc. Further, the point-to-point calculation from source to destination may require large amounts of processing power to perform all of the required calculations. As networks grow in size, the calculation requirements, as well as control plane requirements become impractical. Computations can be a serious bottleneck for fast reliable service setup when accurate physical layer modeling that can incorporate both linear and non-linear effects is employed.

As described further below, route calculation and wavelength assignment for a path may be optimized in order to only perform complex calculations when required. The route and wavelength configuration strategy may provide a simple management layer that requires minimal information from other layers for decision making. The configuration strategy may perform a limited number of complex calculations if necessary, and as such may provide sufficient performance to support real-time application based solutions. The configuration strategy may reduce bandwidth requirements of the control plane by reducing the information required to be communicated over the control plane. The configuration strategy provides reliable information for guaranteed service quality and is scalable for addressing large network sizes and scalability for future hardware and software.

The physical layer offered quality of the signal (Q factor) is typically expressed in terms of optical signal to noise ratio OSNR. The configuration strategy described further below uses OSNR as the metric for determining a path's route and wavelength. It will be appreciated that the OSNR calculation described below could be used in other configuration strategies that use OSNR as one or a plurality of different metrics for determining the route and wavelength assignment. OSNR provides an indication of all attributes of a signal related to its quality. OSNR indicates the degrading effects introduced and experienced by photonic layer components including amplifier, fiber, component effects, etc. A photonic layer link can be modeled by its corresponding OSNR degradation effects. The OSNR may be affected by linear OSNR effects, and in some instances, non-linear OSNR effects. OSNR excludes any performance dependency of the transceivers on the bit rate, coding scheme, constellation, etc. not related to the photonic layer. The performance of transceivers is directly affected by the OSNR of the delivered signal to the receiver (Rx). The specification of a specific transceiver may provide an indication of what OSNR is tolerated by the Rx circuitry. Transceivers typically come with a required OSNR, which is the minimum required optical signal quality at the receiver to have a reliable communications.

OSNR in general includes all the degradation effects experienced in a section of an optical network by an optical signal. There are a variety of parameters which directly and in-directly affect the OSNR of a desired signal. These sources of degradations however can be broadly classified as either linear or non-linear effects. The linear effects are easily and quickly calculated while the non-linear effects may require computationally expensive calculations.

Linear effects are always present and are technology independent. Effects such as the transmission loss, fiber attenuation, coupling inefficiency, dispersion, amplifier amplified spontaneous emission (ASE) noise accumulation, linearly affect the optical signal quality. Linear effects may be expressed mainly as the ratio of the measured power of signal to the in-band noise. The resulting OSNR from the linear effects is simple and fast to calculate as it involves power measurements, which may be made by the various optical components 104. Due to the simplicity of the calculations the OSNR resulting from the linear effects may be calculated at each network access node (104) and communicated to the controller.

Non-linear effects may not be present in every link of an optical network. Non-linear effects may be technology independent. While some non-linear effects such as Stimulated Raman Scattering (SRS), Stimulated Brillouin Scattering (SBS) may be relative easy to calculate, other non-linear effects including the Kerr effect, Self-Phased Modulation (SPM), Cross Phase Modulation (XPM), Four-wave Mixing (FWM), when present, may be dominant non-linear effects. These non-linear effects require extensive calculations to estimate their effects on the OSNR. The linear and non-linear effects also have complex interactions. For an accurate estimation of the OSNR degradation due the non-linear effects, non-linear Schrodinger equation (NLSE) or sophisticated physical layer modeling is used, which requires significant computing power. As such, the non-linear effects on the OSNR may not be easily calculated at the individual optical components. Rather, the measurement information required to calculate the non-linear effects may be collected by the optical components and sent to the controller, which calculates the non-linear effects. Component specific effects may not always be present and are dependent upon the particular technology. The component specific effects may include, for example filtering cross talk, polarization dependent loss (PDL), etc. While linear OSNR can be simply calculated and optimized, non-linear OSNR calculation, estimation and optimization is very difficult in terms of processing and model accuracy as compared to linear. The OSNR values based on the linear effects may be calculated at access nodes of the network and the calculated OSNR values sent to the controller. Additionally or alternatively, the monitored parameters or information may be sent from the access nodes to the controller for calculation of the OSNR values by the controller.

The configuration strategy receives OSNR estimates, or the measurements required to calculate the OSNR estimates, based on linear effects from network components. The OSNR estimates may include an indication as to whether or not a link between network components is experiencing non-linear effects. The route configuration strategy may use the linear OSNR estimates for possible paths, and if the path with the best OSNR value includes a link with non-linear OSNR effects the configuration strategy may then calculate the non-linear effects on the OSNR and update the OSNR value based on the non-linear effects. The updated OSNR value that includes the non-linear effects may then be used in determining the best path for configuring in the optical network. The parameters or other information required for calculating the non-linear effects on the OSNR value may be monitored by components in the optical network and sent to the controller for use in calculating the OSNR value.

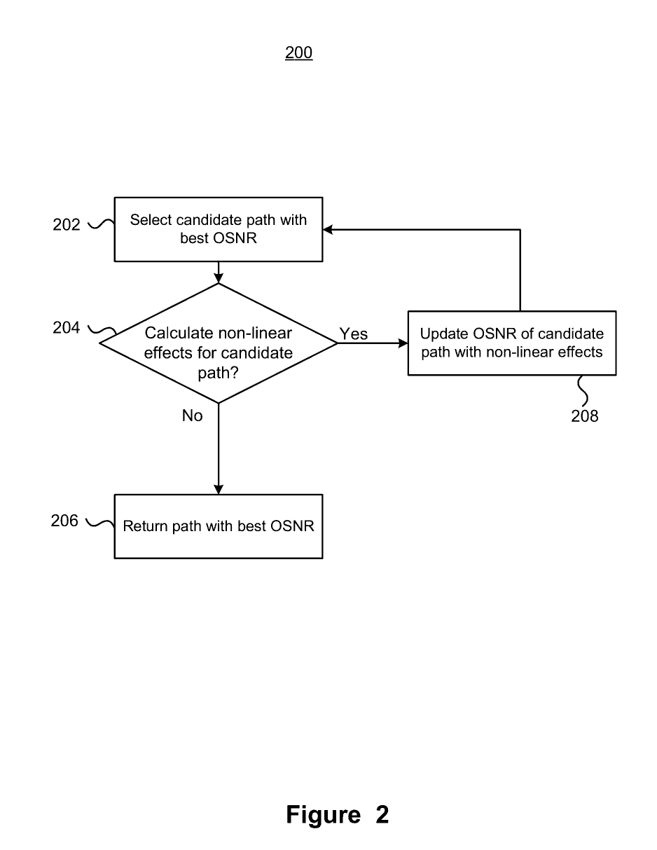

FIG. 2 depicts a method for selecting route based on OSNR. The method 200 assumes that a number of possible paths have already been determined. The determination of the possible paths may be based on a number of factors, including for example OSNR values. The OSNR values used in determining the possible paths may be calculated based on for example the linear effects of the physical layer. The method 200 selects a candidate path from the possible paths that has the best OSNR value (202). The best OSNR value may be the highest value. A determination is made as to whether or not it is necessary to calculate non-linear effects for the candidate path (204). Whether or not it is necessary to determine the non-linear effects may be based on a number of factors, including for example whether or not one or more links of the candidate path suffer from non-linear effects. Further, whether or not to calculate the non-linear effects may depend upon the OSNR of the next best possible path. For example, if the next best possible path is significantly worse than the candidate path by for example some threshold amount, it may not be necessary to calculate the non-linear effects since even when accounting for non-linear effects it may be assumed that the best path will still be the candidate path. Further, it is possible that the OSNR value for the candidate path already includes non-linear effects and as such it is not necessary to determine the effects again. If it is determined that it is not necessary to calculate the non-linear effects (No at 204), the path that was selected as the candidate path is returned (206) and may be used in establishing a light path through the optical network. If however, it is determined that the non-linear effects should be calculated (Yes at 204), the non-linear effects are determined and the OSNR of the candidate path is updated (208) with the OSNR value accounting for the non-linear effects. Once the OSNR value of the candidate path is updated, the best path may be again determined by returning to select the path with the best OSNR value. Although determining the best candidate path after updating the OSNR value may be achieved by returning to select the best OSNR value as depicted, it is possible to first simply check if the updated OSNR value has decreased the candidate path OSNR value below the second best possible path's OSNR value. If the candidate path's updated OSNR value is still better than the next best, it can be returned as the best path.

As described above, an initial path may be selected based on OSNR values determined based on linear effects, which are simple and fast calculations. If the candidate path does not suffer from, or suffers only minimally from, nonlinear effects, the complex calculations for determining the OSNR value based accounting for non-linear effects can be omitted. It is possible to omit the extensive calculations for non-linear effects in other situations. For example if the monitored parameters are similar to previously monitored parameters and the previously monitored parameters were used to calculate non-linear effects on OSNR values, the previously calculated non-linear effects on the OSNR may be used. Whether or not previous non-linear calculations may be reused may account for accuracy of monitored parameters in considering whether previously monitored parameters are sufficiently close enough to current measured parameters as well as the accuracy of the nonlinear effects modeling and calculations.

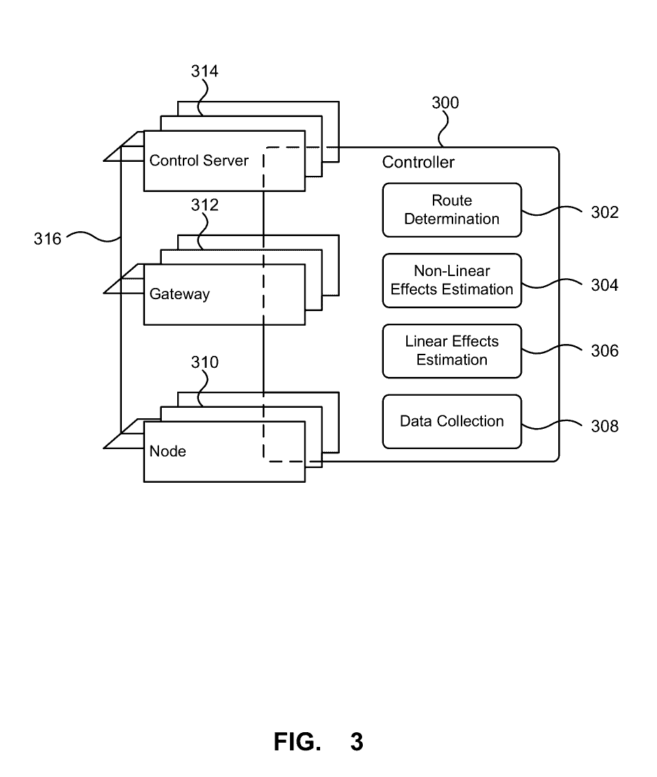

FIG. 3 is a schematic representation of a distributed controller for selecting a route based on OSNR values. As described above with reference to FIG. 1, the optical network and controller may be provided by a plurality of different components, including a plurality of interconnected nodes 104 or switches, one or more gateway nodes 106 that may be in communication with a plurality of the nodes 104 and one or more controllers that control the overall operation of the optical network. As depicted in FIG. 3, the controller functionality described above, as well as that described below, may be distributed among the different hardware components. The controller functionality 300 may be implemented by different hardware of the optical network. As depicted, portions of the controller functionality 300 may be distributed among network nodes 310, gateways 312 and control servers 314. As depicted the various components are communicatively coupled together by a control plane 316. The nodes 310, gateways 312 and control servers 314 can each implement different portions of the controller functionality 300. As will be appreciated, the particular portions of the controller functionality that is implemented in a particular component may vary.

The controller functionality 300 that is distributed amongst numerous components may include route determination functionality 302 that determines the route or path to establish a lightpath between a source and destination. The route determination functionality 302 may make use of linear physical effects to determine the OSNR values. The linear effects on the OSNR may be estimated by linear effects estimation functionality 306. The linear effects estimation functionality 306 may make use of data collected by data collection functionality 308. The data collection functionality 308 may determine the various measurements required to determine the linear effects on the OSNR of a link. The route determination functionality 302 may also make use of non-linear effects estimation functionality 304 in order to estimate OSNR values incorporating linear effects of a link. The controller functionality 300 that is distributed across multiple components can be used to implement route determination using OSNR values based on both linear and non-linear effects of the physical layer.

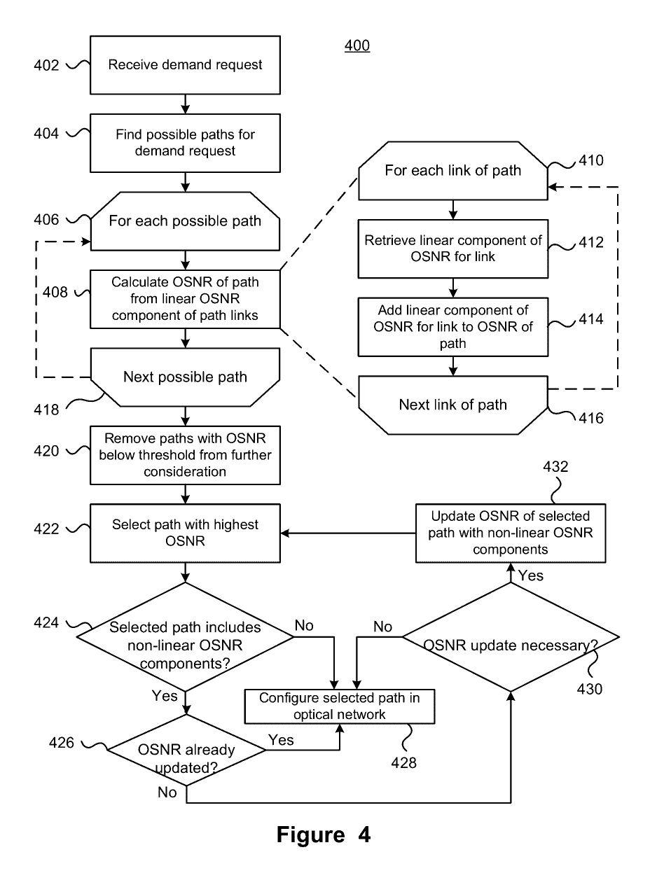

FIG. 4 depicts a method of controlling an optical network. The method may be at least partially implemented in a distributed manner across one or more physical computing devices as described above with respect to the distributed controller functionality 300. The method 400 receives a demand request (402). The demand request may include an indication of source and destination nodes within the optical network that should be connected by a lightpath. The method 400 attempts to determine a path from the source to the destination to satisfy the demand request. Once the demand request is received, the possible path options through the optical network from the source to the destination are determined (404). The determination of the possible path options may account for both the physical connection between access nodes as well as particular wavelength assignments used between the access nodes. The possible path options may be determined using path finding algorithms such as Dijkstra's path finding algorithm or A-Star search. Once the possible paths between the source and the destination are determined, each of the possible paths (406) is processed to calculate the OSNR of the path from the linear OSNR component of each link in the path (408). The OSNR of each of the possible paths may be calculated by processing each link of the path (410). The linear effects on the OSNR, or simply the linear OSNR for brevity, for each link is retrieved (412) and combined with the OSNR of the path (414). The linear OSNR may be retrieved in numerous ways, for example, the linear OSNR may be retrieved by querying the appropriate access node through the control plane. The access node may calculate the linear OSNR value and return it when queried, or may return the measurements used in calculating the linear OSNR. Further, although only the linear information is provided initially, the access node may also provide an indication of whether or not the OSNR is suffering from non-linear effects. Based on monitored parameters, a non-linearity index may be determined or calculated that provides an indication of a severity of the non-linear effects of the link. Additionally or alternatively, the linear OSNR could be retrieved from a cache or temporary store that stores the linear OSNR for a period of time. The length of time that the linear OSNR may be stored may depend upon a rate that the OSNR of the node changes. Once the linear OSNR of the link has been added to the OSNR of the path, the next link of the path (416) is processed until all of the links of the path have been processed. The next possible path (418) is processed until the OSNR of all of the OSNR of all of the possible paths have been calculated.

When the OSNR of all of the paths have been calculated based on the linear OSNR of the nodes, possible paths with an OSNR below a threshold are removed from further consideration (420). The particular threshold used may depend upon characteristics of the destination node as well as other characteristics. For example, the receiver at the destination may require to have a particular minimum OSNR in order to provide a particular performance, such as bit error rate (BER). Other network layer data may also be used to remove the remaining paths such as the number of hops, latency, etc. Once the paths with OSNRs below the threshold are removed from further consideration, the path with the highest OSNR is selected (422) and it is determined if the selected path includes a link that may experience non-linear OSNR effects (424). In order to select the path with the highest OSNR, the paths may be ordered based on the OSNR values. As noted above, when retrieving the linear OSNR information, each node also provides an indication of whether or not the access node is experiencing non-linear OSNR effects. If the path includes a link experiencing non-linear effects (Yes at 424), it is determined if the OSNR of the path has already been updated to account for the non-linear effects on the OSNR (426). The determination of whether or not the OSNR has already been updated to account for non-linear effects may include a determination of how recently the OSNR was updated. For example, if the OSNR value was previously updated a day ago, it may be necessary to update the OSNR value as the non-linear effects may have changed over the day. If the OSNR of the selected path has been updated to account for the non-linear effects (Yes at 426), then the selected path is considered the best path and the optical network may be configured according to the path (428). Further, if the selected path is not associated with non-linear effects (No at 424), the selected path is considered the best path and can be configured in the optical network (424).

If the OSNR has not been updated to account for the non-linear effects (No at 426), it is determined if it is necessary to update the OSNR of the path to incorporate the non-linear effects (430). Whether or not it is necessary to determine the non-linear effects on the OSNR may depend upon one or more factors. For example, if the OSNR value of the second best path is significantly worse than that of the best path, it may be assumed that even if the non-linear effects are accounted for the path will still have a higher OSNR value and as such it does not need to be calculated. Further, the decision on whether or not it is necessary to update the OSNR value to account for non-linear effects may depend on other factors such as a load of the network, importance of the traffic, quality of service associated with the traffic, available margin for the corresponding transponder, uncertainty related to measurement and modeling of nonlinear effects, as well as other possible factors. If it is determined to be necessary to update the OSNR (Yes at 430), the OSNR value of the path is updated in order to account for the non-linear effects of the links of the path (432). When the OSNR is updated, the non-linear OSNR information may be retrieved from the network access nodes and the non-linear effects calculated. It is noted that the complex and data intensive non-linear calculations are only performed if required. The non-linear effects will always negatively impact the OSNR and as such, if the path is selected as the best path, it is necessary to determine if the non-linear effects impact the OSNR to such a degree that the selected path is no longer the best path. When the OSNR of the path has been updated to include the non-linear effects of any links in the path experience non-linear effects, the path with the highest OSNR is re-selected (422). If the selected path is determined to again have a non-linear OSNR component (Yes at 424) but it is determined that the OSNR has already been updated to account for the non-linear effects (Yes at 424), then the selected path is considered the best path and the optical network may be configured according to the path (428). Further, if the selected path is not associated with non-linear effects (No at 416), the selected path is configured in the optical network (430). If it is determined not necessary to update the OSNR values to account for the non-linear effects (No at 430), the selected path can be assumed to be the best, and used in configuring the optical network (428).

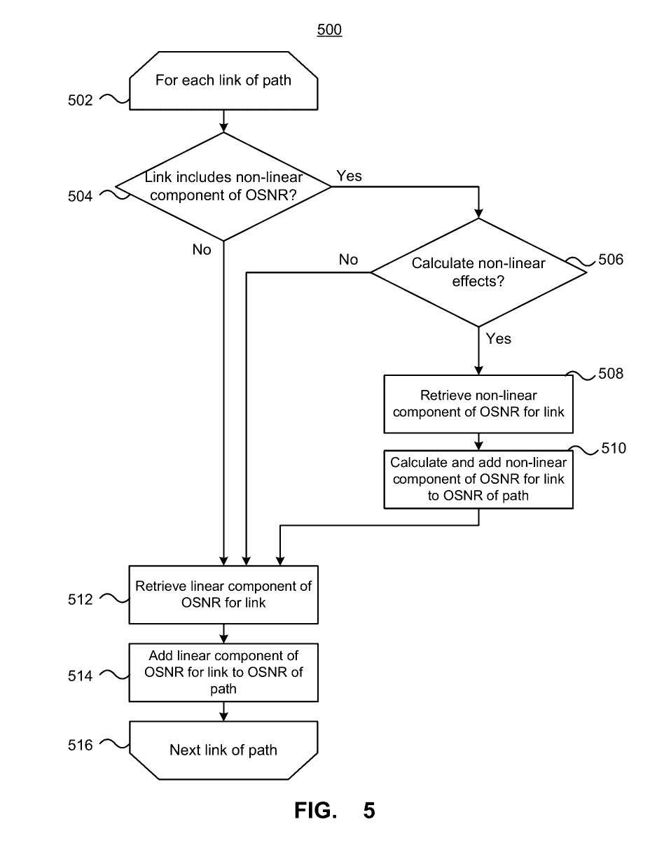

FIG. 5 depicts a method of determining an optical signal to noise ratio (OSNR) for a path. The method 500 may be used to update the OSNR of paths with links experiencing non-linear effects, for example in the method 400 described above. The method 500 processes each link on the path being updated. For each link of the path (502), it is determined if the link includes non-linear OSNR components (504). If the link includes non-linear OSNR components (Yes at 504), it is determined whether or not the non-linear effects need to be calculated for the particular link (506). The determination of whether or not the non-linear effects for a link need to be calculated may be based on an impact of the possible non-linear effects of the link may have on the total non-linear effects of the path, or even based on the history of demands established over the path. For example if the launched power per wavelength per span is less than a critical threshold, then the impact of nonlinear effects may be considered to be minor and as such not necessary to calculate. Similar considerations can be applied for channel spacing of WDM channels in each link/span. If the non-linear component should be calculated (Yes at 506), the non-linear OSNR information is retrieved for the link (508) and the non-linear effects on the OSNR are calculated and added to the OSNR of the path (510). After calculating and adding the non-linear effects of the link (510), or if the link does not include non-linear OSNR components (No at 504), or if it is not necessary to calculate the non-linear component (No at 504), the linear component of the OSNR link may be retrieved (512) and added to the OSNR of the path (514). It is noted that if the linear OSNR of the path has already been calculated, it may only be necessary to account for the non-linear OSNR effects. Once the link is processed, the next link of the path (516) is processed.

The methods 400 and 500 described above provide illustrative methods for determining an optical path through a network. However, the particular details described in the methods 400 and 500 may be varied. For example, the OSNR calculation described above may be combined together into a single process. Regardless of the specifics, the methods determine nonlinear effects on a link only when required. An initial path determination may be done based on linear OSNR values, which are easily and quickly calculated. If the path having the best OSNR value as determined based on linear effects is suffering from non-linear effects, the OSNR value for the path may be updated based on the non-linear effects. A flag or indicator may be used to check if non-linear effects should be accounted for a possible path. The flag or indicator may be simply calculated locally at the access nodes, or possibly estimated or calculated at the control agent. As a simple example for calculating the flag or indicator, power deviations may be checked and once the deviations reach a certain threshold nonlinear effects may need to be considered for the link and so the flag or indicator may be set accordingly.

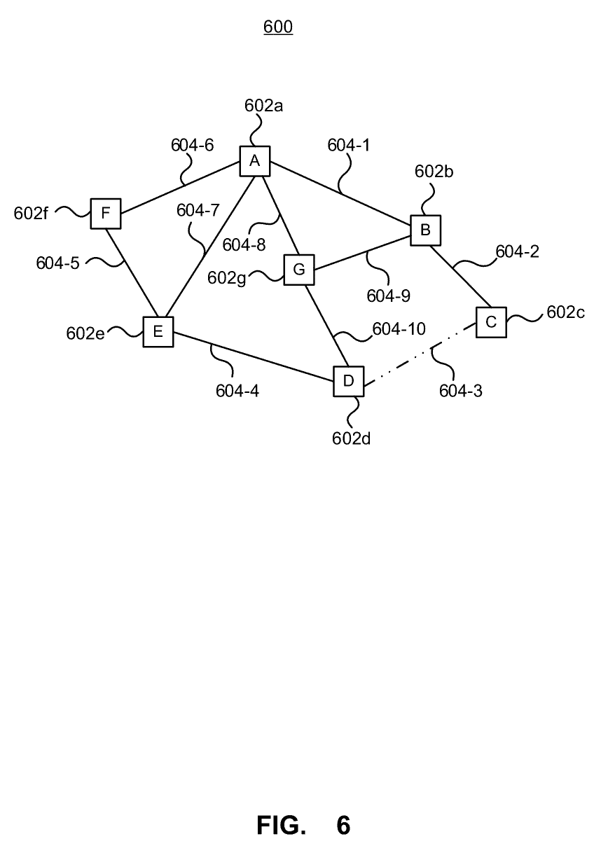

FIG. 6 depicts an example optical network. The illustrative network 600 comprises a plurality of access nodes 602a, 602b, 602c, 602d, 602e, 602f, 602g that are connected by a plurality of fiber optic connections 604-1, 604-2, 604-3, 604-4, 604-5, 604-6, 604-7, 604-8, 604-9, 604-10. The optical network 600 includes one link 604-3 suffering from non-linear effects as illustrated by the broken line. In the following examples, it is assumed that the source is access node A 602a and the destination node is access node B 602B. There are a number of paths from source to destination and for the following examples it is assumed that the paths have an OSNR above the required threshold include:

| Path | Non-linear Effects |
|---|---|
| AB | No |
| AGB | No |
| AFEDCB | Yes |
| AEDCB | Yes |
| AEDGB | No |

Table 1 showing paths and associated non-linear effects

In order to determine a path between the source and destination, when establishing a lightpath, the paths can be ordered according to their linear OSNR, which is a fast process and consumes negligible timing no matter what network components perform the computation, such as locally at the access node or at the control plane, at centralized controller or a distributed control. Different examples are depicted in Tables 2-4. As depicted in Table 2, the path with the highest linear OSNR (AB) does not suffer from any non-linear effects and as such, it can be selected as the path without having to perform any of the complex computations required for calculating the non-linear effects. The avoidance of the non-linear calculations can greatly simplify and speed up the path finding calculations and also may require less data to be sent over the control plane. It is noted that practical limitations in the dynamic range and accuracy of optical power meters of detectors have been omitted from consideration for simplicity and clarity of the description.

| Path | Non-linear Effects | OSNR (dB) |
|---|---|---|
| AB | No | 22 |
| AGB | No | 21.5 |
| AFEDCB | Yes | 20 |
| AEDGB | No | 19.5 |
| AEDCB | Yes | 18 |

Table 2 showing paths, non-linear effects and OSNR values

As depicted in Table 3, when initially calculating the OSNR based only on the linear effects, the path AEDCB has the best OSNR. However, because the path is affected by non-linear effects, it is necessary to calculate the non-linear effects on the OSNR, which as depicted in Table 3 result in lowering the OSNR by 1.5 and as such, once the paths are reordered based on the updated OSNRs, the best path will be AGB. It is noted that the best path was calculated incorporating non-linear effects of the physical layer, however, the non-linear calculations were performed for only a single link, namely link DC in the path. As a result path AGB is selected with only one set of non-linear calculations for link DC, i.e., minimal computation.

| Path | Non-linear Effects | OSNR (dB) | Non-linear OSNR (dB) |
|---|---|---|---|
| AEDCB | Yes | 22 | −1.5 |
| AGB | No | 21.5 | |
| AB | No | 20 | |
| AEDGB | No | 19.5 | |
| AFEDCB | Yes | 18 | |

Table 3 showing paths, non-linear effects and OSNR values and determined non-linear effects on the OSNR value

As depicted in Table 4, when initially calculating the OSNR based only on the linear effects, the path AEDCB has the best OSNR. However, because the path is affected by non-linear effects, it is necessary to calculate the non-linear effects on the OSNR, which as depicted in Table 4 result in lowering the OSNR by 1.5 and as such, once the paths are reordered based on the updated OSNRs, the best path will be AFEDCB. However, the selected path is again a non-linear path and as such the non-linear effects on the OSNR are again calculated, which as depicted in Table 4, result in lowering the OSNR by 0.5 dB. When reordered, the best path is AFEDCB and because it is based on the OSNR calculation that accounts for the non-linear effects it can be selected as the path for configuring the desired lightpath. It is noted that the best path was calculated incorporating non-linear effects of the physical layer, however, the non-linear calculations were performed for only two paths. It is noted that although the non-linear link is the same in both paths, the effect on the OSNR may differ, for example the two different paths may use different wavelengths which have different non-linear effects on the OSNR.

| Path | Non-linear Effects | OSNR (dB) | Non-linear OSNR (dB) |
|---|---|---|---|
| AEDCB | Yes | 22 | −1.5 |
| AFEDCB | Yes | 21.5 | −0.5 |
| AB | No | 20 | |
| AEDGB | No | 19.5 | |
| AGB | No | 18 | |

Table 4 showing paths, non-linear effects and OSNR values and determined non-linear effects on the OSNR value

As described above, the route and wavelength configuration reduces the number of calculations used to account for non-linearities. The search space is significantly reduced by looking at the regions of the network which qualify for the desired or required OSNR determined based on only the linear OSNR component. Path options may be sorted based on linear OSNR and the path options suffering from non-linear effects are marked. Non-linear calculations are performed only when needed for links suffering from non-linearities. This may only happen when a path option or options suffering from non-linear effects offer better linear OSNR. Non-linear effects may be calculated for those with linear OSNRs better than the best candidate not suffering from non-linear effects, or candidates that have already been updated to account for the non-linear effects.

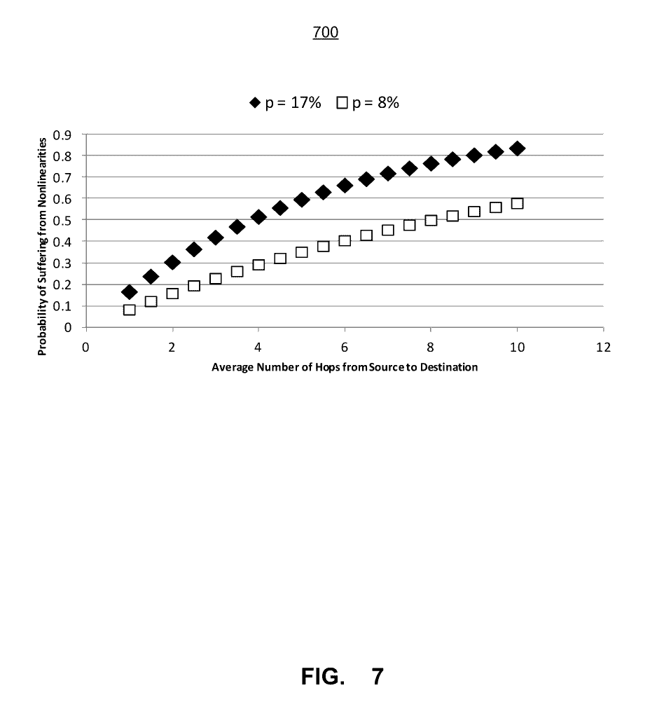

FIG. 7 is a graph of the average probability of a path suffering from non-linear effects. The graph 700 assumes that each link has a probability of p of experiencing non-linearities. If a path on average has H hops or links, the probability the path has no non-linearity is equal to the probability that all of the hops each has no non-linearity, which is given by (1-p)^{H}. This assumes the non-linearity of each path is independent from others. The probability a path suffers from non-linearities is, hence, 1-(1-p)^{H}. The graph 700 shows the probability of a path suffering from non-linearities based on the number of hops from source to destination. The probability of suffering from non-linearities is depicted for different probabilities of a link in the optical network from suffering non-linearities. For example, if 17% of the links suffer from non-linearities, than for an average of 2 hops, there is approximately a 30% chance of suffering a non-linearity and as such, 70% the OSNR is completed described by the linear component. Accordingly, the method described above allows the correct path to be determined without having to calculate non-linearities.

The configuration strategy eliminates, or at least reduces, the complex calculations for unnecessary cases where non-linear calculation is not required. The search space for optimal solution is minimized and extensive calculations are performed only when needed and therefore a significant speed improvement may be achieved.

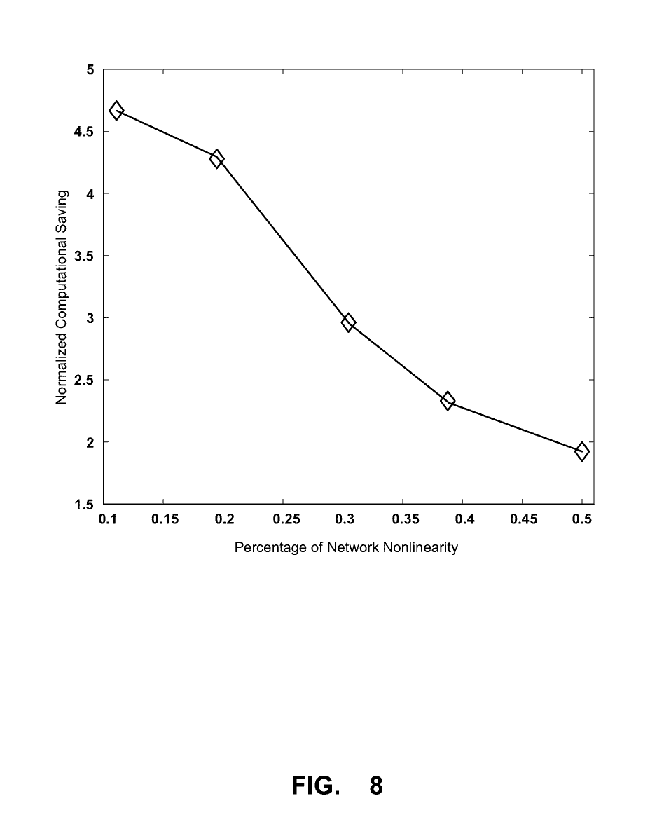

FIG. 8 is a graph of computational savings based on percentage of non-linear links in a network. As depicted, as the percentage of the network suffering from non-linearities increases, the computational savings of the above strategy for computing the route and wavelength assignments including non-linear information decreases. If approximately half of the links of the optical network suffer from non-linear effects there will be an approximately 2× gain in the computational savings. The computational savings increase as the percentage of non-linear links in the optical network decreases.

The architecture may be significantly simplified and modularized using the configuration strategy by employing big data analysis and mining. The strategy makes the integration of higher layers with the physical layer service agnostic. The described interactions between the RWA layer and physical layer may be independent of what service type is requested. A limited amount of data is sent to the control layer.

While the current spectrum utilization is based on ITU 50GHz grid, optical networks are moving towards a flexgrid network where channels are spaced closer and there is no pre-defined grid which significantly increases the bandwidths utilization. The configuration strategy may be transparent to any specific assumption on the spectral grid hence will easily support next gen networks.

Although the above has described configuring a route and wavelength of a lightpath based solely on the OSNR, it is possible to account for other factors, such as geographic constraints of access nodes, cost consideration, service level agreements, network load and other factors as well. Alternatively, the configuration of the route and wavelength may be done including the non-linear links but treating all non-linear links as linear links.

The present disclosure provided, for the purposes of explanation, numerous specific embodiments, implementations, examples and details in order to provide a thorough understanding of the invention. It is apparent, however, that the embodiments may be practiced without all of the specific details or with an equivalent arrangement. In other instances, some well-known structures and devices are shown in block diagram form, or omitted, in order to avoid unnecessarily obscuring the embodiments of the invention. The description should in no way be limited to the illustrative implementations, drawings, and techniques illustrated, including the exemplary designs and implementations illustrated and described herein, but may be modified within the scope of the appended claims along with their full scope of equivalents.

While several embodiments have been provided in the present disclosure, it should be understood that the disclosed systems and components might be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

What is claimed is:

1. A method for determining a route from a source to a destination of an optical network, the method comprising:
determining an optical signal to noise ratio (OSNR) value for each one of a plurality of paths through the optical network from the source to the destination;
selecting, as a candidate path, a path having the best OSNR value from the plurality of paths;
determining if non-linear effects should be calculated for the candidate path;
calculating non-linear effects for the candidate path and updating the OSNR value of the candidate path using the calculated non-linear effects when it is determined that non-linear effect should be calculated for the candidate path; and
selecting a path from the plurality of paths having the best OSNR value as the route from the source to the destination.

2. The method of claim 1, wherein determining if non-linear effects should be calculated for the candidate path comprises determining if the candidate path includes at least one link suffering from non-linear effects.

3. The method of claim 2, wherein determining if the candidate path includes at least one link suffering from non-linear effects is based on one or more monitored parameters from one or more network components along the candidate path in the optical network.

4. The method of claim 3, wherein determining if the candidate path includes at least one link suffering from non-linear effects comprises:
determining for one or more links that one or more parameters have crossed a threshold; and
setting a non-linearity index flag for the one or more links that are determined to have one or more parameters that have crossed the threshold.

5. The method of claim 3, wherein the one or more monitored parameters are:
requested from at least one of the one or more network components when required for determining if the candidate path includes at least one link suffering from non-linear effects;
periodically requested from at least one of the one or network components;
periodically received from at least one of the one or network components; or
received from at least one of the one or network components when one or more of the monitored parameters changes more than a threshold amount.

6. The method of claim 2, wherein determining if non-linear effects should be calculated for the candidate path further comprises determining if the non-linear effects have already been calculated when it is determined the candidate path includes at least one link suffering from non-linear effects.

7. The method of claim 6, wherein determining if non-linear effects should be calculated for the candidate path further comprises, when the non-linear effects have already been calculated, determining if the non-linear effects already calculated should be updated.

8. The method of claim 2, wherein determining if non-linear effects should be calculated for the candidate path further comprises determining if a second-best OSNR value of the plurality of paths is within a threshold of the OSNR value of the candidate path.

9. The method of claim 1, wherein determining if non-linear effects should be calculated for the candidate path comprises determining if the OSNR value of the candidate path is within an acceptable range threshold for the destination.

10. The method of claim 1, wherein selecting the path having the best OSNR value as the route comprises verifying that the updated OSNR value of the candidate path is the best OSNR value.

11. The method of claim 1, wherein selecting the path having the best OSNR value as the route comprises selecting another candidate path having the best OSNR value.

12. The method of claim 1, wherein selecting the path having the best OSNR value as the route comprises recursively applying the method for determining the route until the selected candidate path does not need to have non-linear effects of the candidate path calculated.

13. The method of claim 1, wherein determining the OSNR value for each one of the plurality of paths comprises:
determining the OSNR value of each link of the respective path based on linear effects of the link.

14. The method of claim 1, wherein determining the OSNR value for each one of the plurality of paths comprises determining OSNR values for one or more assigned wavelengths on each link of the respective path based on linear effects of the link for the wavelength.

15. The method of claim 1, wherein the linear effects include one or more of:
transmission loss;
fiber attenuation;
coupling inefficiency; and
amplifier noise.

16. The method of claim 1, wherein the calculation of the non-linear effects include one or more of:
Stimulated Raman Scattering (SRS);
Stimulated Brillouin Scattering (SBS);
Optical Kerr effect;
Self Phased Modulation (SPM);
Cross Phase Modulation (XPM); and
Four-Wave Mixing (FWM).

17. The method of claim 16, wherein the calculation of non-linear effects incorporates one or more linear effects.

18. The method of claim 1, further comprising establishing the route within the optical network.

19. A controller for determining a route from a source to a destination of an optical network, the controller comprising:
at least one memory unit for storing instructions;
at least one processor for executing instructions stored in the at least one memory unit, the executed instructions configuring the controller to carry out a method for determining a route from a source to a destination of the optical network, the method comprising:
determining an optical signal to noise ratio (OSNR) value for each one of a plurality of paths through the optical network from the source to the destination;
selecting, as a candidate path, a path having the best OSNR value from the plurality of paths;
determining if non-linear effects should be calculated for the candidate path;
calculating non-linear effects for the candidate path and updating the OSNR value of the candidate path using the calculated non-linear effects when it is determined that non-linear effect should be calculated for the candidate path; and
selecting a path, of the plurality of paths, having the best OSNR value as the route from the source to the destination.

20. The controller of claim 19, wherein the at least one memory unit and at least one processor comprise a plurality of memory units and a plurality of processors of network components of the optical network.

21. The controller of claim 20, wherein the network components comprise one or more of:
a plurality of access nodes;
a plurality of optical switches;
one or more gateways; and
one or more control servers.

22. The controller of claim 21, wherein the plurality of network components are communicatively coupled by a control plane.

23. The controller of claim 21, wherein determining the OSNR values for each of the plurality of paths and calculating the non-linear effects is based on one or more monitored parameters from one or more network components in the optical network.

24. The controller of claim 23, wherein the one or more gateways:
periodically retrieve at least one of the monitored parameters from one or more of the plurality of optical switches and store in at least one of the one or more control servers; or
retrieve at least one of the monitored parameters from one or more of the plurality of optical switches when determining the OSNR values or calculating the non-linear effects.

25. The controller of claim 23, wherein one or more of the plurality of optical switches:
periodically push at least one of the monitored parameters; or
push at least one of the monitored parameters when the monitored parameters change.
